(19) United States
(12) Patent Application Publication
(10) Pub. No.: US 2025/0162358 A1
(43) Pub. Date: May 22, 2025

(54) HITCH BALL HOOK DEVICE

(71) Applicant: Ting LUO, Jinhua (CN)

(72) Inventor: Ting LUO, Jinhua (CN)

(21) Appl. No.: 18/395,796

(22) Filed: Dec. 26, 2023

(30) Foreign Application Priority Data
Nov. 16, 2023 (CN) 2023231049080

(51) Int. Cl. B60D 1/07; B60D 1/06; B60D 1/46; B60D 1/52

(52) U.S. Cl. CPC B60D 1/07; B60D 1/065; B60D 1/46; B60D 1/52

(57) ABSTRACT

A hitch ball hook device includes a hitch ball pendant and a hitch arm body, the hitch ball hook device further includes a square steel configured to connect to a vehicle receiver, the hitch ball pendant includes a hitch ball seat, and the hitch ball seat includes at least a hitch ball; the hitch ball pendant further includes a holding jaw, and the holding jaw is disposed at a front end of the hitch ball. The hitch arm body includes: two side walls, and the hitch arm body defines a vertical groove disposed between the two side walls; a front end of the holding jaw abuts against the vertical groove, and the holding jaw is connected to the hitch arm body through the two side walls. The device has a reasonable structure, strong practicality, is convenient use and greatly improving work efficiency.

### TECHNICAL FIELD

The disclosure relates to the technical field of connecting device for hitching recreational vehicle (RV), and particularly to a hitch ball hook device.

### BACKGROUND

The hitching recreational vehicles do not have an independent drive system and need to be connected to the hitching vehicle through a connecting device, which provides the driving force to drive.

The structures of the connecting device have a directly impact on connection stability between the hitching recreational vehicles and hitching vehicles, the trailer hitches of the connecting device are generally fixed on the rear bumper of the hitching vehicle in the prior art, and the carrying capacity of the trailer hitches is concentrated at a point on the rear bumper of the hitching vehicle, which makes the connection stability lower.

In addition, in the prior art, some of the hitching hook devices include the hitch ball pendant and the hitch arm body, but the connection between the hitch ball pendant and the hitch arm body is not tight enough. When in use, there may be a certain gap between the hitch ball pendant and the hitch arm body through shaking, which affects the safety of use. Moreover, the existing hitching hook device is not flexible enough for assembly and disassembly, making it inconvenient to use, resulting in long assembly and disassembly time and low work efficiency.

### SUMMARY

The main purpose of the disclosure is to provide a novel hitch ball hook device, which is reasonable in structure, strong in practicality, flexible in installation and disassembly, convenient to use, safer and more reliable, and greatly improves the work efficiency.

In order to achieve above purpose, the hitch ball hook device is provided, the hitch ball hook device includes: a hitch ball pendant and a hitch arm body, the hitch ball hook device further includes a square steel configured to connect to a vehicle receiver, the hitch ball pendant includes a hitch ball seat, and the hitch ball seat includes at least a hitch ball; the hitch ball pendant further includes a holding jaw, and the holding jaw is disposed at a front end of the hitch ball seat. The hitch ball seat defines a through groove penetrating the hitch ball seat to the holding jaw. The hitch arm body includes: two side walls, and the hitch arm body defines a vertical groove disposed between the two side walls; a front end of the holding jaw abuts against the vertical groove, and the holding jaw is connected to the hitch arm body through the two side walls.

In an embodiment, the hitch ball pendant includes: two hitch balls, and the two hitch balls are respectively disposed up and down on the hitch ball pendant.

In an embodiment, the hitch ball hook device further includes: at least a latch, disposed at the side walls of the hitch arm body, and the holding jaw is connected to the hitch arm body through the latch.

In an embodiment, the latch is provided with an R-shaped pin.

In an embodiment, the hitch ball hook device further includes: a first tightening screw disposed in the through groove, and the hitch ball pendant is connected to the hitch arm body through the first tightening screw.

In an embodiment, the hitch ball hook device further includes: a handle disposed on the hitch ball seat, and the handle is connected to the first tightening screw.

In an embodiment, the front end of the holding jaw defines transverse grooves, and the holding jaw is divided into an upper holding jaw and a lower holding jaw by the transverse grooves.

In an embodiment, the hitch ball hook device further includes: rubber rings disposed on the square steel.

In an embodiment, the hitch ball hook device further includes: an iron ring disposed on the square steel, and the iron ring abuts against the rubber rings.

In an embodiment, the hitch ball hook device further includes: at least a receiver pin disposed on the square steel and configured to connect to the vehicle receiver.

The beneficial effects of the disclosure are as follows.

A hitch ball hook device includes a hitch ball pendant and a hitch arm body, the hitch ball hook device further includes a square steel configured to connect to a vehicle receiver, the hitch ball pendant includes a hitch ball seat, and the hitch ball seat includes at least a hitch ball; the hitch ball pendant further includes a holding jaw, and the holding jaw is disposed at a front end of the hitch ball seat. The hitch arm body includes: two side walls, and the hitch arm body defines a vertical groove disposed between the two side walls; a front end of the holding jaw abuts against the vertical groove, and the holding jaw is connected to the hitch arm body through the two side walls.

Through the above structural arrangement, the hitch ball pendant and the hitch arm body of the hitch ball hook device of the disclosure are more tightly connected, which greatly improves safety and reliability during use.

The hitch ball hook device of the disclosure is strong in practicality, flexible and convenient in installation and disassembly, reasonable in structure, and improves the work efficiency, which is suitable for widespread promotion and use.

### BRIEF DESCRIPTION OF DRAWINGS

In order to provide a clearer explanation of the embodiments of the disclosure or the technical solutions in the prior art, a brief introduction will be given to the attached drawings required in the description of the embodiments or the prior art. It is evident that the attached drawings in the following description are only some of the embodiments of the disclosure. For those skilled in the art, other attached drawings can be obtained based on the structures shown in the drawings without any creative effort.

FIG. 1 illustrates a structural schematic diagram of a hitch ball hook device in an embodiment of the disclosure.

FIG. 2 illustrates another structural schematic diagram of the hitch ball hook device in the embodiment of the disclosure.

FIG. 3 illustrates a section schematic diagram of the hitch ball hook device in the embodiment of the disclosure.

FIG. 4 illustrates a structural schematic diagram of a hitch ball pendant of the hitch ball hook device in the embodiment of the disclosure.

FIG. 5 illustrates an exploded diagram of the hitching hook device in the embodiment of the disclosure.

The implementation, functional features, and advantages of the disclosure will be further explained in conjunction with the embodiments, with reference to the attached drawings.

### DETAILED DESCRIPTION OF EMBODIMENTS

The following will provide a clear and complete description of the technical solution in the embodiments of the disclosure in conjunction with the attached drawings. Obviously, the described embodiments are only a part of the embodiments of the disclosure, not all of them. Based on the embodiments in the disclosure, all other embodiments obtained by those skilled in the art without creative labor fall within the scope of protection of the disclosure.

It should be noted that all directional indications (such as up, down, left, right, front, rear . . . ) in the embodiments of the disclosure are only used to explain the relative position relationship, motion situation among components in a specific posture (as shown in the attached drawings). If the specific posture changes, the directional indication also changes accordingly.

In the disclosure, unless otherwise clearly defined and limited, the terms “connection” and “fixed” should be understood broadly, for example, “fixed” can be a fixed connection, a detachable connection, or a whole; it can be a mechanical connection or an electrical connection; it can be directly connected or indirectly connected through an intermediate medium, which can be the internal connection between two components or the interaction relationship between two components, unless otherwise specified. For those skilled in the art, the specific meanings of the above terms in the disclosure can be understood based on specific circumstances.

In addition, if there are descriptions of “first” and “second” in the embodiments of disclosure, the descriptions of “first” and “second” are only used for descriptive purposes and cannot be understood as indicating or implying their relative importance or implying the number of indicated technical features. Therefore, features limited to “first” and “second” can explicitly or implicitly include at least one of these features. Moreover, the meaning of “and/or” appearing in the entire text includes three parallel schemes. Taking “A and/or B” as an example, it includes a scheme A, or a scheme B, or a scheme that both includes A and B. And the technical solutions between various embodiments can be combined with each other, but must be based on the ability of those skilled in the art to achieve. When the combination of technical solutions conflicts or cannot be achieved, it should be considered that the combination of such technical solutions does not exist and is not within the protection scope required by the disclosure.

The disclosure provides a hitch ball hook device.

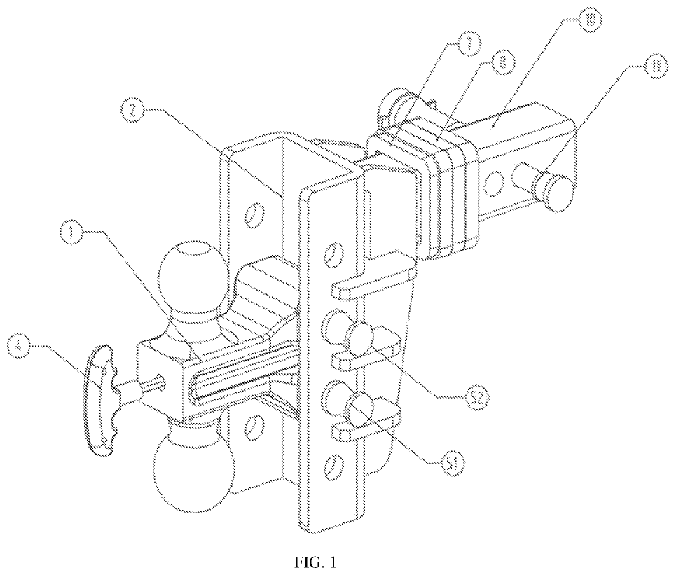

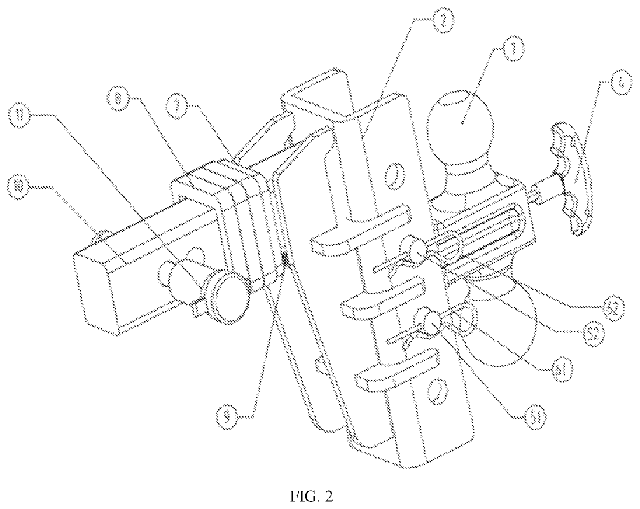

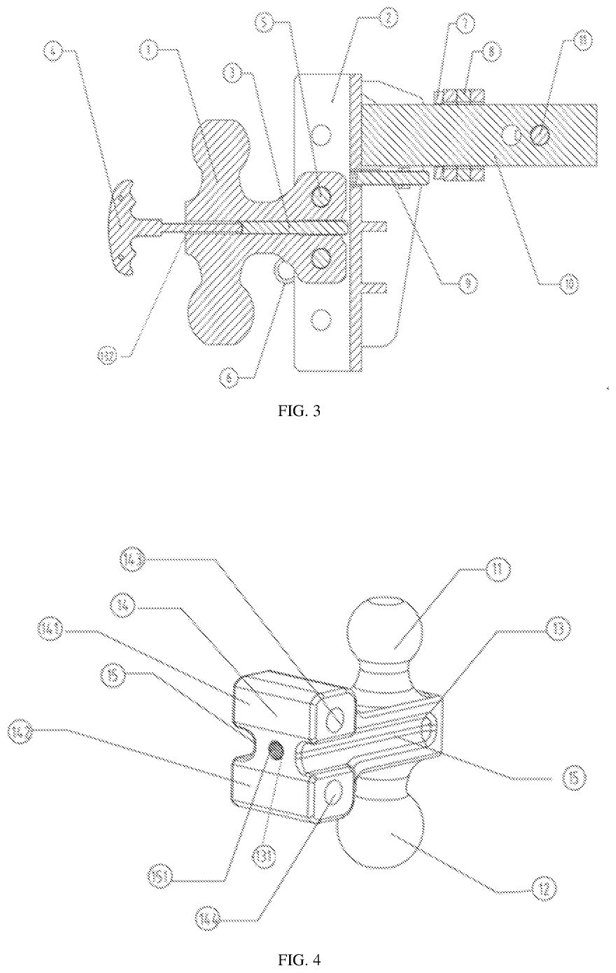

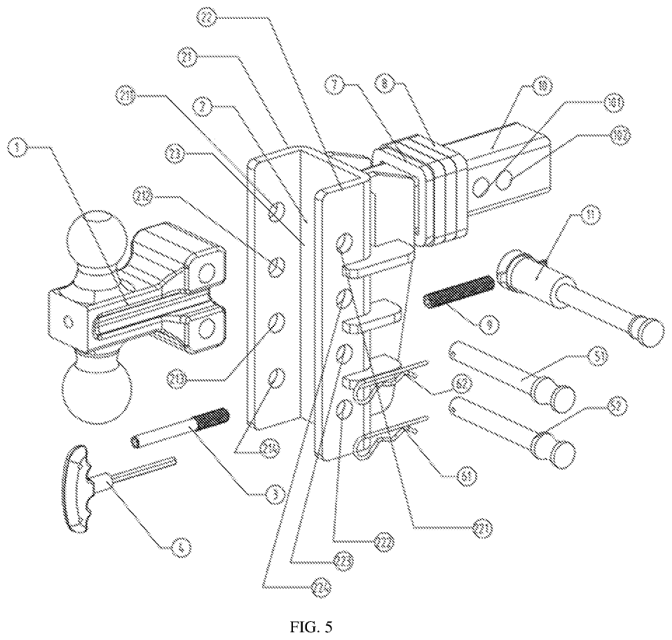

As shown in FIGS. 1-5, an embodiment of the disclosure provides a hitch ball hook device, which includes: a hitch ball pendant 1, a hitch arm body 2 and a square steel 10 connected to the hitch arm body 2. The square steel 10 is configured to connect to a vehicle receiver, the hitch ball pendant 1 includes: a hitch ball seat 13, and the hitch ball seat 13 includes: at least a hitch ball. The hitch ball pendant 1 further includes: a holding jaw 14, and the holding jaw 14 is disposed at a front end of the hitch ball seat 13. The hitch ball seat 13 defines a through groove 131 penetrating the hitch ball seat 13 to the holding jaw 14. The hitch arm body 2 includes a first side wall 21 and a second side wall 22, and the hitch arm body 2 defines a vertical groove 23 between the first side wall 21 and the second side wall 22. A front end of the holding jaw 14 abuts against the vertical groove 23, and the holding jaw 14 is connected to the hitch arm body 2 through the first side wall 21 and the second side wall 22.

In an embodiment, the hitch ball pendant 1 includes: two hitch balls of a first hitch ball 11 and a second hitch ball 12, the first hitch ball 11 and the second hitch ball 12 are respectively disposed up and down on the hitch ball pendant 1. Certainly, multiple hitch balls can be disposed on the hitch ball pendant 1 according to actual needs. The hitch balls are used to connect a towing device of an RV.

In the embodiment, as shown in FIGS. 1-5, the hitch ball pendant 1 includes: the hitch ball seat 13, and the hitch ball seat 13 includes: at least the first hitch ball 11 and the second hitch ball 12, the hitch ball seat 13 defines the through groove 131, and the through groove 131 penetrates the hitch ball seat 13 to the holding jaw 14, that is to say, the through groove 131 extends from the hitch ball seat 13 to the holding jaw 14. The hitch arm body 2 includes the first side wall 21 and the second side wall 22, the first side wall 21 and the second side wall 22 form a semi-enclosed shape, and the hitch arm body 2 defines the vertical groove 23 between the first side wall 21 and the second side wall 22. The holding jaw 14 abuts against the vertical groove 23 of the hitch arm body 2, and the holding jaw 14 is connected to the hitch arm body 2 through the first side wall 21 and the second side wall 22.

In an embodiment, the first side wall 21 can define multiple through holes, and the second side wall 22 can also define multiple through holes correspondingly. In an embodiment, the first side wall 21 defines a first through hole 211, a second through hole 212, a third through hole 213, and a fourth through hole 214. The second side wall 22 defines a fifth through hole 221, a sixth through hole 222, a seventh through hole 223, and an eighth through hole 224. Positions of the first through hole 211, the second through hole 212, the third through hole 213, and the fourth through hole 214 correspond to positions of the fifth through hole 221, the sixth through hole 222, the seventh through hole 223, and the eighth through-hole 224, respectively.

The through groove 131 inside of the hitch ball seat 13 divides the holding jaw 14 into an upper holding jaw 141 and a lower holding jaw 142. The upper holding jaw 141 defines a ninth through hole 143, and the lower holding jaw 142 defines a tenth through hole 144.

In an embodiment, the side walls of the hitch arm body 2 are provided with at least a latch. Specifically, the first side wall 21 and the second side wall 22 of the hitch arm body 2 are provided with a first latch 51 and a second latch 52. When in use, the ninth through hole 143 and the tenth through hole 144 of the holding jaw 14 are respectively aligned with the second through hole 212 and the third through hole 213 of the first side wall 21, and the ninth through hole 143 and the tenth through hole 144 of the holding jaw 14 are respectively aligned with the sixth through hole 222 and the seventh through hole 223 of the second side wall 22. The first latch 51 and the second latch 52 are used to connect the holding jaw 14 and the hitch arm body 2 by passing through the second through hole 212, the ninth through hole 143 and the sixth through hole 222, and the third through hole 213, the tenth through hole 144 and the seventh through hole 223, respectively.

In an embodiment, the holding jaw 14 can move back and forth along the vertical groove 23 of the hitch arm body 2 to find an appropriate position, and then connect the holding jaw 14 to the hitch arm body 2 through the latches.

In an embodiment, the first latch 51 is provided with a first R-shaped pin 61, and the second latch 52 is provided with a second R-shaped pin 62. The first R-shaped pin 61 and the second R-shaped pin 62 are respectively used to fix the first latch 51 and the second latch 52, to prevent the first latch 51 and the second latch 52 from falling out during vehicle bumps and other reasons.

In an embodiment, as shown in FIG. 4, the hitch ball seat 13 defines a first circular hole 132 at an end of the through groove 131 facing the hitch balls, the holding jaw 14 defines a second circular hole 151 at another end of the through groove 131 facing the holding jaw 14, and a first tightening screw 3 is disposed in the through groove 131. The hitch ball pendant 1 is connected to the hitch arm body 2 through the first tightening screw 3. That is to say, the hitch ball pendant 1 is connected to the hitch arm body 2 by the first tightening screw 3 to penetrate out the second circular hole 151.

In an embodiment, a handle 4 is disposed on the hitch ball seat 13, and the handle 4 is connected to the first tightening screw 3 by penetrating out the first circular hole 132.

In the embodiment, the handle 4 is used to tighten the first tightening screw 3, thereby making the holding jaw 14 and the hitch arm body 2 tightly connected, which makes it more convenient to use.

In an embodiment, the front end of the holding jaw 14 defines transverse grooves 15, the second circular hole 151 is disposed at a center position between the transverse grooves 15, and the holding jaw 14 is divided into an upper holding jaw 141 and a lower holding jaw 142 by the transverse grooves 15.

In the embodiment, the hitch ball pendant 1 is used to tightly connect the holding jaw 14 and the hitch arm body 2 through the first latch 51 and the second latch 52, and the holding jaw 14 is connected to the hitch arm body 2 through the first tightening screw 3 disposed in the through groove 131. The tight connection between the hitch ball pendant 1 and the hitch arm body 2 not only makes it more stable and safer to use, but also reduces the risk of detachment between the hitch ball pendant 1 and the hitch arm body 2 during towing, making it more reliable and safer to use.

In the embodiment, the hitch arm body 2 is used to connect, fix, and adjust the ground clearance of the hitch balls, making it easier for the hitch balls to adapt to other vehicles of different heights that need to be towed. Simultaneously, the hitch arm body 2 is used to limit the position of left and right translation for the hitch ball pendant. The latches inserted into the circular holes (i.e., through holes) of the sides of the holding jaw limit the position of up, down, front and back translation for the hitch ball pendant 1.

In an embodiment, as shown in FIGS. 1-2 and 3-5, specifically, the hitch ball hook device further includes: rubber rings 8, the rubber rings 8 are disposed on the square steel 10, the rubber rings 8 are used to increase friction and reduce noise when connecting the hitch arm body 2 to the RV receiver (i.e., the vehicle receiver).

In an embodiment, specifically, the hitch ball hook device further includes: an iron ring 7, the iron ring 7 is disposed on the square steel 10, and the iron ring 7 abuts against the rubber rings 8.

In an embodiment, specifically, the hitch ball hook device further includes: a second tightening screw 9, the second tightening screw 9 is disposed at a bottom of a connection between the square steel 10 and the hitch arm body 2, and the second tightening screw 9 is used to firmly fix the hitch arm body 2 to the vehicle receiver.

In a specific embodiment, the iron ring 7 is used to increase the contact area between the second tightening screw 9 and the rubber rings 8, making the rubber rings 8 work better.

In an embodiment, specifically, the square steel 10 defines a third circular hole 101 and a fourth circular hole 102 on side walls of the square steel 10, and the square steel 10 is provided with a receiver latch lock 11 for connecting the vehicle receiver.

The receiver latch lock 11 can be inserted into the third circular hole 101 or the fourth circular hole 102 to connect the square steel 10 to the vehicle receiver. The receiver latch lock 11 has an anti-theft function.

The hitch ball hook device of the disclosure has a reasonable structure and strong practicality, effectively reducing the shaking gap between the hitch ball pendant 1 and the hitch arm body 2 during use, making it safer and more reliable, and effectively reducing the abnormal noise caused by vehicle body shaking.

The above is only an optional embodiment of the disclosure and does not limit the scope of the patent of the disclosure. Any equivalent structural changes made using the description and attached drawings of the disclosure, or directly/indirectly applied in other related technical fields, are included in the scope of patent protection of the disclosure.

What is claimed is:

1. A hitch ball hook device comprising: a hitch ball pendant and a hitch arm body;
wherein the hitch ball hook device further comprises: a square steel connected to the hitch arm body and configured to connect to a vehicle receiver; the hitch ball pendant comprises: a hitch ball seat, and the hitch ball seat comprises: at least a hitch ball; the hitch ball pendant further comprises: a holding jaw, and the holding jaw is disposed at a front end of the hitch ball seat;
wherein the hitch ball seat defines a through groove penetrating the hitch ball seat to the holding jaw;
wherein the hitch arm body comprises: two side walls, and the hitch arm body defines a vertical groove disposed between the two side walls; a front end of the holding jaw abuts against the vertical groove, and the holding jaw is connected to the hitch arm body through the two side walls.

2. The hitch ball hook device as claimed in claim 1, wherein the hitch ball pendant comprises: two hitch balls, and the two hitch balls are respectively disposed up and down on the hitch ball pendant.

3. The hitch ball hook device as claimed in claim 2, wherein the hitch ball hook device further comprises: at least a latch, disposed at the side walls of the hitch arm body, and the holding jaw is connected to the hitch arm body through the latch.

4. The hitch ball hook device as claimed in claim 3, wherein the latch is provided with an R-shaped pin.

5. The hitch ball hook device as claimed in claim 4, wherein the hitch ball hook device further comprises: a first tightening screw disposed in the through groove, and the hitch ball pendant is connected to the hitch arm body through the first tightening screw.

6. The hitch ball hook device as claimed in claim 5, wherein the hitch ball hook device further comprises: a handle disposed on the hitch ball seat, and the handle is connected to the first tightening screw.

7. The hitch ball hook device as claimed in claim 6, wherein the front end of the holding jaw defines transverse grooves, and the holding jaw is divided into an upper holding jaw and a lower holding jaw by the transverse grooves.

8. The hitch ball hook device as claimed in claim 1, wherein the hitch ball hook device further comprises: rubber rings disposed on the square steel.

9. The hitch ball hook device as claimed in claim 8, wherein the hitch ball hook device further comprises: an iron ring disposed on the square steel, and the iron ring abuts against the rubber rings.

10. The hitch ball hook device as claimed in claim 9, wherein the hitch ball hook device further comprises: at least a receiver pin disposed on the square steel and configured to connect to the vehicle receiver.

11. The hitch ball hook device as claimed in claim 5, wherein the hitch ball hook device further comprises: a second tightening screw disposed at a bottom of a connection between the square steel and the hitch arm body, and the second tightening screw is configured to fix the hitch arm body to the vehicle receiver.

12. A hitch ball hook device comprising:
a square steel, configured to connect to a vehicle receiver;
a hitch arm body, comprising: two side walls connected to the square steel; wherein the hitch arm body defines a vertical groove disposed between the two side walls;
a hitch ball pendant, detachably connected to the hitch arm body; wherein the hitch ball pendant comprises: a hitch ball seat and a holding jaw connected to the hitch ball seat; the hitch ball seat comprises: at least a hitch ball, a front end of the holding jaw abuts against the vertical groove, and the hitch ball seat defines a through groove penetrating the hitch ball to the holding jaw;
a latch, penetrating through the two side walls to connect the holding jaw with the hitch arm body; and
a tightening screw, disposed in the through groove; wherein the hitch ball pendant is connected to the hitch arm body through the tightening screw.

13. The hitch ball hook device as claimed in claim 12, wherein the hitch ball hook device further comprises: an R-shaped pin, and the latch defines a hole configured for passing through the R-shaped pin; and
wherein one of the two side walls defines a plurality of first through holes, the holding jaw defines a plurality of second through holes, and the other side wall defines a plurality of third through holes; and the hitch arm body and the hitch ball pendant is connected by the latch sequentially penetrating one of the plurality of first through holes, a corresponding one of the second through holes, and a corresponding one of the plurality of third through holes.
